(19) United States
(12) Patent Application Publication
(10) Pub. No.: US 2023/0363486 A1
(43) Pub. Date: Nov. 16, 2023

(54) A FOOTWEAR AND A METHOD FOR MANUFACTURING A FOOTWEAR USING DIRECT INJECTION PROCESS

(71) Applicant: ECCO Sko A/S, Bredebro (DK)

(72) Inventor: Frank Jensen, Bredebro (DK)

(21) Appl. No.: 18/030,967

(22) PCT Filed: Oct. 11, 2021
(86) PCT No.: PCT/DK2021/050305

§ 371 Date: Apr. 7, 2023

(30) Foreign Application Priority Data
Oct. 9, 2020 (DK) PA 2020 70686

(51) Int. Cl. A43B 3/10; A43B 3/12; B29D 35/00; B29D 35/06; B29C 45/00; B29C 45/33

(52) U.S. Cl. CPC A43B 3/102; A43B 3/122; B29D 35/0036; B29D 35/062; B29C 45/0062; B29C 45/33; B29C 2045/0063; B29L 2031/504

(57) ABSTRACT

A method and a system for manufacturing a footwear. The footwear includes a footwear upper and a sole. The footwear upper has a lower end. The sole has an upper facing surface, a ground facing surface, and a side surface. The sole side surface includes a lateral side surface and medial side surface. The footwear upper lower end is attached to the side surface of the sole at least partly by a direct injection process of the sole. The direct injection process of the sole is being provided via a mold including at least two side mold parts. method and a system for manufacturing the footwear.

### FIELD OF THE INVENTION

The invention relates to a footwear according to claim 1.

The invention further relates to a method of manufacturing a footwear and a system for manufacturing footwear.

### BACKGROUND OF THE INVENTION

It is known in the art to manufacture footwear by means of direct injection of the sole to the upper.

The direct injection process (DIP) is advantageous in many ways as the manufactured footwear may be produced to possess both flexibility and strength at the same time.

A challenge in relation to such a direct injection process is that the method of manufacture requires at least a partly fixation of the footwear upper for an optimal moulding process and footwear manufacturing.

DE 3242586 A1 discloses a method and a device for manufacturing footwear, e.g. sandals, whereby the footwear upper is partly fixated. The device comprises a matrix, which has a contoured recess, into which the footwear upper of a sandal can be positioned in an upside-down position. The device further comprises two mould parts, which both are hinged to the matrix on top of this. One of these mould parts is hollow, corresponds to the shape of the footwear and may be received in the upper part of the matrix. The other mould part is flat and may define the pattern of the ground facing part of the sole, when closed down as a cover for the matrix. When manufacturing a sandal, the footwear upper is placed in the recess of the matrix, the two mould parts are successively closed down in such a manner that the ends of the footwear upper (i.e. the upper lower ends as seen with the footwear in its normal use position) are positioned between the matrix wall and the hollow mould part. Subsequently, the sole may be injection moulded via a moulding material inlet, whereby the ends of the footwear upper are fastened to the sole at the same time as the sole is moulded. In order to hold the ends of the footwear upper in the position between the matrix wall and the hollow mould part, e.g. towards the matrix wall, a pair of vacuum arrangements may be positioned on each side of the matrix.

As it will be apparent, this prior art requires that must there be sufficient if not ample clearances between the ends of the footwear upper and the matrix wall/the hollow mould part, which may lead to seeping or escaping of the injection material at these places, which again requires subsequent trimming of the excess material. To reduce this problem, the device may be designed with very small tolerances between the matrix wall/the hollow mould part and the ends of the footwear upper, which, however, will mean that it will be difficult to position the upper and difficult to close the mould device, because the ends of the footwear upper may easily come in the way. This may furthermore lead to that the ends of the footwear upper even may be dislocated from the position, in which they have been put, when the hollow mould part is closed down on the matrix and hence lead to interruptions in the manufacturing and possibly faulty products.

### SUMMARY OF THE INVENTION

The invention relates to a footwear, comprising a footwear upper and a sole, wherein the footwear upper has a lower end, wherein the sole has an upper facing surface, a ground facing surface and a side surface, wherein the sole side surface comprises a lateral side surface and medial side surface, wherein the footwear upper lower end is attached to the side surface of the sole at least partly by a direct injection process of the sole, said direct injection process of the sole being provided via a mould comprising at least two side mould parts.

The inventive footwear has several advantages over prior art involving an efficient attachment of a footwear upper to a footwear sole.

Hereby, a strong attachment of the upper to the sole is obtained. The direct injection process forms a watertight seal without using glue or stitching which furthermore allows the shoe to be highly flexible.

The present invention makes it possible to attach a footwear upper to a footwear sole in the same manufacturing process and thereby minimizing handling processes such as e.g. gluing and/or stitching.

Further, the present invention simplifies the process of making footwear and has less handling compared to the conventional way. Multiple upper designs can be used in the same side moulds and thereby reducing cost and handling.

By the invention it is furthermore achieved that a footwear such as a sandal according to the invention has the lower end of the upper attached to the side surface of the sole with a desired accuracy and consistency, as the footwear upper lower end is attached to the side surface of the sole at least partly by a direct injection process of the sole, wherein said direct injection process of the sole is being provided via a mould comprising at least two side mould parts. Thus, such a mould is being closed by moving the at least two side mould parts, one at each side of the mould, towards each other, to a position, where the two side mould parts close e.g. horizontally toward e.g. a mould closing member, a last, a dummy last or the like, and whereby the footwear upper lower end, e.g. one upper lower end on each side of the sole, is/are being positioned at least partly by the e.g. horizontally moving two side mould parts. Thus, it will be seen that the two side mould parts will not cause any e.g. detrimental dislodging or disturbing of the footwear upper lower end as might be the case in connection with the prior art as disclosed by DE 3242586 A1, where vertically moving mould parts that move perpendicular to the footwear sole may interfere with and possibly disturb or dislodge the footwear upper lower end. Furthermore, by the invention it may be achieved that the footwear such as a sandal may be produced with only minor and possibly no excess moulding material on the sole, e.g. moulding material that has escaped and should be removed by e.g. trimming, which is achieved by the direct injection process of the sole being provided via the mould comprising at least two side mould parts that will facilitate efficient closing of the mould cavity, e.g. due to the e.g. horizontal movement of the two side mould parts from each side and e.g. perpendicular to the axial direction of the footwear upper lower end, which upper lower end may be provided with e.g. one upper lower end on each side of the sole.

It is noted that when referring to side mould parts, e.g. “at least two side mould parts”, it should be understood that these correspond to “side moulds”, e.g. the first side mould and the second side mould as disclosed in the following.

According to embodiments of the invention, the footwear upper is attached to the lateral side surface and medial side surface respectively.

According to embodiments of the invention, the footwear is a sandal.

According to embodiments of the invention, the footwear upper lower end is at least partly fixated to the mould prior to the direct injection process.

Hence, the two side mould parts will even more so not cause any disadvantageous effect on the footwear upper lower end, when the two side mould parts are moved to close the mould. Due to the two side mould parts being moved in a direction essentially perpendicular to the footwear upper lower ends, e.g. essentially perpendicular to the plane of the footwear upper lower end, there will not be caused any scraping, grinding or the like along the footwear upper lower ends or other forms of interaction that may e.g. transfer friction and cause the footwear upper lower ends to be e.g. displaced.

According to embodiments of the invention, the fixation of the footwear upper to the mould is mediated by vacuum.

The side moulds may be modified with milled space for the upper and vacuum holes and channels, and the side moulds may be connected to a vacuum system.

Hereby, the vacuum keeps the position of the upper during the direct injection process and thereby a conventional last and lasting processes may not be necessary.

According to embodiments of the invention, the fixation of the footwear upper to the mould is mediated by glue.

Hereby, fixating the footwear upper to the mould initially or prior to the direct injection process minimises the use and investment in machine lasts.

An advantage is further that during manufacturing of a footwear and importantly during the manufacturing of a direct injection processed sole, it is not necessary to provide a footwear upper with a stitched insole placed on a last.

According to embodiments of the invention, the direct injection process comprises direct injection process material.

According to embodiments of the invention, the direct injection process material is TPR, PVC, EVA, TPU and/or PU.

According to embodiments of the invention, the direct injection material is PU.

According to embodiments of the invention, the direct injection material mediates the attachment of the footwear upper at least to the sole side surface.

According to embodiments of the invention, the sole comprises TPR, PVC, EVA, TPU and/or PU.

According to embodiments of the invention, the sole comprises PU.

According to embodiments of the invention, the sole comprises at least one material.

According to embodiments of the invention, the sole comprises an insole.

According to embodiments of the invention, the sole is contoured.

According to embodiments of the invention, the footwear upper comprises leather.

According to embodiments of the invention, the leather is natural leather.

According to embodiments of the invention, the leather is bovine leather.

According to embodiments of the invention, the leather is tanned bovine leather.

According to embodiments of the invention, the tanned bovine leather comprises tanning agents in the amount of 1 to 20% by weight of the leather.

According to embodiments of the invention, the tanning agents includes chrome tanning agents.

According to embodiments of the invention, the tanning agents includes vegetable tanning agents.

According to embodiments of the invention, the footwear upper comprises at least one layer of material.

According to embodiments of the invention, the at least one layer of material comprises leather.

According to embodiments of the invention, the footwear upper comprises a leather flesh side and wherein the leather flesh side is attached to the sole side surface.

An advantage of a footwear upper comprising a leather flesh side attached to the sole side surface is that the process of roughing is diminished or absent for the adherence of the footwear upper to the sole. Hereby, it is possibly to use all the top grain leather for the upper and obtain an effective and maximal utilization of the leather.

The process of roughing should be understood as a scratching or loosening process of the leather fibers to ensure that the material binds sufficiently.

According to embodiments of the invention, the footwear upper comprises textile.

According to embodiments of the invention, the footwear upper comprises a reinforcing fabric.

According to embodiments of the invention, the footwear upper comprises regenerated fibers.

According to embodiments of the invention, the footwear upper comprises staple fibers.

According to embodiments of the invention, the footwear upper comprises at least one strap.

According to embodiments of the invention, the at least one strap is adjustable.

According to embodiments of the invention, the footwear upper comprises at least two parts.

Advantages of adjustable straps or an adjustable closure system help anchor the foot and provide greater stability and support.

According to embodiments of the invention, the footwear upper and the sole is manufactured using different materials, and wherein the footwear upper comprises at least 60% of a first material and at least 60% of a second material.

According to embodiments of the invention, the first material is leather.

According to embodiments of the invention, the second material is PU.

Examples hereof may be that the upper is manufactured in e.g. leather and the sole is manufactured in e.g. PU.

According to embodiments of the invention, the footwear upper lower end is attached to the side surface of the sole by a side surface attachment length.

According to embodiments of the invention, the side surface attachment length is less than 10 cm, such as less than 5 cm, such as less than 4 cm, such as less than 3 cm, such as less than 2 cm, such as less than 1 cm.

According to embodiments of the invention, the side surface attachment length is between 10 cm to 0.1 cm, such as between 7 cm to 0.5 cm, such as between 3 cm to 1 cm.

According to embodiments of the invention, the footwear upper lower end is attached to the side surface of the sole by a total circumference attachment length.

According to embodiments of the invention, the total circumference attachment length is at least 3 mm, such as at least 7 mm, such as at least 1 cm, such as at least 2 cm, such as at least 4 cm, such as at least 6 cm, such as at least 8 cm, such as at least 10 cm, such as at least 12 cm, such as at least 14 cm, such as at least 16 cm, such as at least 18 cm, such as at least 20 cm, such as at least 25 cm, such as at least 30 cm, such as at least 35 cm.

According to embodiments of the invention, the total circumference attachment length is at least 1%, such as at least 5%, such as at least 10%, such as at least 20%, such as at least 30%, such as at least 40%, such as at least 50%, such as at least 70%, such as 100%.

According to embodiments of the invention, the total circumference attachment length is between 1% and 100%, such as between 10% and 70% and wherein the side surface attachment length is between 10 cm to 0.2 cm, such as between 4 cm to 0.5 cm, such as between 3 cm to 1 cm.

According to embodiments of the invention, the footwear comprises a footbed.

According to embodiments of the invention, the footbed comprises a sock.

According to embodiments of the invention, the footbed comprises a sock, cork, leather, foam, gasket and/or PU.

According to embodiments of the invention, the attachment forces between the lower end of the footwear upper and the outer surface of the sole is at least 5 kN/m, more typically above 10 kN/m, or even above 15 kN/m when measured according to ISO 3376: 2011.

The attachment forces, the ultimate tensile strength expressed in kN/m is the pulling force required to break a 1 m wide sample of the material. A suitable test for measuring the ultimate tensile strength of the reinforcing fabric is ISO 3376: 2011. An alternative test specifically adapted for testing tensile properties of polymer matrix composites which could be used is ASTM D3039.

The invention further relates to a method for manufacturing a footwear, said method comprising the steps of
providing a footwear upper, wherein the footwear upper comprises a footwear upper lower end,
providing a mould, wherein the mould comprises at least two side mould parts,
fixating the footwear upper lower end at least partly to the two side moulds,
providing a mould closing member,
closing the mould,
injecting direct injection material into the mould by a direct injection process for the manufacturing of a sole, wherein the sole comprises a side surface and thereby attaching the footwear upper lower end to the side surface of the sole at least partly by the direct injection process of the sole.

The inventive method has several advantages over prior art involving facilitating an efficient attachment of a footwear upper to a footwear sole.

By the method, a strong attachment of the upper to the sole is obtained. The direct injection process forms a watertight seal without using e.g. glue or stitching which furthermore allows the shoe manufactured by the method to be highly flexible.

The present invention makes it possible to attach a footwear upper to a footwear sole in the same manufacturing process and thereby minimizing handling processes such as e.g. gluing and/or stitching.

Further, the present inventive method simplifies the process of making footwear and has less handling compared to the conventional methods. Multiple upper designs can be used in the same side moulds and thereby reducing cost and handling.

By the invention it is furthermore achieved that a footwear such as a sandal by the method according to the invention has the lower end of the upper attached to the side surface of the sole with a desired accuracy and consistency, as the footwear upper lower end is attached to the side surface of the sole at least partly by a direct injection process of the sole, wherein said direct injection process of the sole is being provided via a mould comprising at least two side mould parts. Thus, such a mould is being closed by moving the at least two side mould parts, one at each side of the mould, towards each other, to a position, where the two side mould parts close e.g. horizontally toward e.g. a mould closing member, a last, a dummy last or the like, and whereby the footwear upper lower end, e.g. one upper lower end on each side of the sole, is/are being positioned at least partly by the e.g. horizontally moving two side mould parts. Thus, it will be seen that the two side mould parts will not cause any e.g. detrimental dislodging or disturbing of the footwear upper lower end as might be the case in connection with the prior art as disclosed by DE 3242586 A1, where vertically moving mould parts that move perpendicular to the footwear sole may interfere with and possibly disturb or dislodge the footwear upper lower end. Furthermore, by the method it may be achieved that the footwear such as a sandal may be produced with only minor and possibly no excess moulding material on the sole, e.g. moulding material that has escaped and should be removed by e.g. trimming, which is achieved by the direct injection process of the sole being provided via the mould comprising at least two side mould parts that will facilitate efficient closing of the mould cavity, e.g. due to the e.g. horizontal movement of the two side mould parts from each side and e.g. perpendicular to the axial direction of the footwear upper lower end, which upper lower end may be provided with e.g. one upper lower end on each side of the sole.

According to embodiments of the invention, fixating the footwear upper lower end at least partly to the mould is mediated by vacuum.

Hereby, the fixating of the footwear upper lower end may be provided in an efficient manner, e.g. by simply positioning the footwear upper lower end at the intended position, whereby it will be gripped and fixated. Further, the subsequent removal of the footwear upper lower end, e.g. together with the sole after the sole has been moulded may be effected in various ways, e.g. by reducing or closing off of the vacuum, etc. The positioning may be effected manually or in an at least partially automated manner.

According to embodiments of the invention, the direct injection moulding material is PU.

According to embodiments of the invention, the footwear upper lower end is at least partly fixated to the mould prior to the direct injection process.

According to embodiments of the invention, the footwear upper and the sole is manufactured using different materials, and wherein the footwear upper comprises at least 60% of a first material and at least 60% of a second material.

According to embodiments of the invention, the footwear upper comprises a leather flesh side and wherein the leather flesh side is attached to the sole side surface.

According to an embodiment of the invention, at least one of the at least two side mould parts of the mould may be pivotable and wherein, prior to fixating the footwear upper lower end at least partly to the two side moulds, said at least one of the at least two side mould parts of the mould has been pivoted, e.g. outwards, to facilitate access for positioning the footwear upper lower end.

Hereby, an improved efficiency may be achieved, e.g. since the improved access allows a faster positioning and thus manufacturing to be achieved, which may also reduce manufacturing costs. Furthermore, the improved access may also result in an improved quality, e.g. since the footwear upper lower end may be positioned with greater accuracy.

According to an embodiment of the invention, the step of closing the mould may comprise moving said at least two side mould parts towards said mould closing member from each side of the mould closing member.

Hereby, it may be achieved that a potential risk of e.g. disturbing or otherwise interfering with the footwear upper lower end during the movement of the at least two side mould parts is minimized or even avoided, e.g. as opposed to the scenario as disclosed by the prior art of DE 3242586 A1, where the movable mould parts may e.g. scrape over or otherwise transfer friction to the footwear upper lower end during the movement, which may cause undesirable effects.

According to an embodiment of the invention, the footwear upper lower end that has been fixated at least partly to the two side moulds, may be moved in a direction essentially perpendicular to the footwear upper lower end when closing the mould.

Hereby, it is even further effected that a potential risk of e.g. disturbing or otherwise interfering with the footwear upper lower end during the movement of the at least two side mould parts is minimized or even avoided as compared to the prior art of DE 3242586 A1.

According to an embodiment of the invention, the mould may comprise a bottom mould and wherein the bottom mould may be moved upwards prior to and/or during the step of injecting direct injection material into the mould to position the bottom mould at a position corresponding to a desired thickness of the sole.

According to embodiments of the invention, the method is applied for producing a footwear according to embodiments of the invention.

According to a further aspect, the invention relates to a system for manufacturing footwear by a direct injection process, said system comprising a mould for direct injection, wherein the mould comprises at least two side mould parts, said at least two side mould parts each being configured for at least partly fixating a footwear upper lower end to the mould for direct injection.

The system according to the invention has a number of advantages over prior art systems such as advantages involving facilitating an efficient attachment of a footwear upper to a footwear sole.

By use of the system, a strong attachment of the upper to the sole is obtained. The direct injection process forms a watertight seal without using e.g. glue or stitching which furthermore allows the shoe manufactured by use of the system to be highly flexible.

The present invention makes it possible to manufacture a footwear including attaching a footwear upper to a footwear sole in the same manufacturing process and thereby minimizing handling processes such as e.g. gluing and/or stitching.

Further, the system simplifies the process of making footwear and involves less handling compared to the conventional systems. Multiple upper designs can be used in the same side moulds and thereby reducing cost and handling.

By the invention it is furthermore achieved that a footwear such as a sandal by use of the system according to the invention has the lower end of the upper attached to the side surface of the sole with a desired accuracy and consistency, as the footwear upper lower end is attached to the side surface of the sole at least partly by a direct injection process of the sole, wherein said direct injection process of the sole is being provided via the mould comprising the at least two side mould parts. Thus, such a mould is being closed by moving the at least two side mould parts, one at each side of the mould, towards each other, to a position, where the two side mould parts close e.g. horizontally toward e.g. a mould closing member, a last, a dummy last or the like, and whereby the footwear upper lower end, e.g. one upper lower end on each side of the sole, is/are being positioned at least partly by the e.g. horizontally moving two side mould parts. Thus, it will be seen that the two side mould parts will not cause any e.g. detrimental dislodging or disturbing of the footwear upper lower end as might be the case in connection with the prior art as disclosed by DE 3242586 A1, where vertically moving mould parts that move perpendicular to the footwear sole may interfere with and possibly disturb or dislodge the footwear upper lower end. Furthermore, by use of the system it may be achieved that the footwear such as a sandal may be produced with only minor and possibly no excess moulding material on the sole, e.g. moulding material that has escaped and should be removed by e.g. trimming, which is achieved by the direct injection process of the sole being provided via the mould comprising at least two side mould parts that will facilitate efficient closing of the mould cavity, e.g. due to the e.g. horizontal movement of the two side mould parts from each side and e.g. perpendicular to the axial direction of the footwear upper lower end, which upper lower end may be provided with e.g. one upper lower end on each side of the sole.

According to an embodiment of the invention, said at least two side mould parts may comprise a first side mould and a second side mould, each being configured for at least partly fixating a footwear upper lower end to the mould for direct injection, said first side mould and said second side mould comprising a first fixating side wall and a second fixating side wall, respectively.

It is noted that the first fixating side wall and the second fixating side wall may be configured to facilitate positioning the footwear upper lower end, e.g. by being at least partly recessed, e.g. by milling, by providing at least a lower supporting protrusion, etc.

According to an embodiment of the invention, one or both of said at least two side mould parts may be pivotable.

Hereby it may be achieved that when the mould is being opened, e.g. including tilting or pivoting at least one of the at least two side mould parts outwards, the room for accessing the inside of the at least two side mould parts, e.g. the fixating side walls, is increased, leading to an improved access. Thus, an improved efficiency may be achieved, e.g. since the improved access allows a faster positioning and thus manufacturing to be achieved, when using the system, which may also reduce manufacturing costs. Furthermore, the improved access may also result in an improved quality of the manufacturing, e.g. since the footwear upper lower end may be positioned with greater accuracy.

It is noted that the terms “pivotable” and “tiltable” may be used interchangeably in the context of the present invention. Similar applies as regards e.g. the terms “pivot” and “tilt” and the like.

According to an embodiment of the invention, said at least two side mould parts may each be configured for at least partly fixating said footwear upper lower end by vacuum.

Hereby, the system may provide the advantage of fixating the footwear upper lower end an efficient manner, e.g. by simply positioning the footwear upper lower end at the intended position, whereby it will be gripped and fixated. Further, the subsequent removal of the footwear upper lower end, e.g. together with the sole after the sole has been moulded may be effected in various ways, e.g. by reducing or closing off of the vacuum, etc. The positioning may be effected manually or in at least partially automated manner.

Further, as the vacuum keeps the position of the upper during the direct injection process, a conventional last and lasting processes may not be necessary when using the system according to the present invention.

The side mould parts, e.g. the side moulds may be modified with a recessed, e.g. milled space to accommodate the upper. Further, vacuum holes and/or vacuum channels may be provided in the side moulds, which may be connected to a vacuum system, e.g. via one or more vacuum conducting members.

According to an embodiment of the invention, the system may further comprise a movable bottom mould.

According to an embodiment of the invention, the system may further comprise a mould closing member.

According to an embodiment of the invention, said system may be configured for performing a method according to the invention.

The footwear according to embodiments of the invention may be any type of footwear such as e.g. a sneaker, sport's shoe, formal shoe, boot, lace up shoe, slip ons, loafers, sandals or any other type of footwear.

Sandals should be understood as an open type of footwear, consisting of a sole held to the wearers foot by a strap or straps going over the instep and sometimes around the ankle. Sandals may also have a heel. Sandals vary in how much of the foot that is exposed, however, the common understanding is that a sandal leaves all or most of the foot exposed.

The sandals according to embodiments of the invention may be any type of sandals such as flip flops, sports sandals, everyday flats, dressy flats, slides, wedge sandals, gladiator sandals, thong sandals or any other type of sandal.

The upper according to embodiments of the invention may be of any material such as e.g. leather, natural leather, textile, reinforcing fabric, reconstructed fibers, woven or non-woven material based on natural or synthetic fibers or any other type of material.

Leather may be any type of leather such as e.g. full grain or top leather, corrected or embossed grain, split suede, nubuck sueded grain, reconstructed, reconstituted, bonded or fiber leather or any other type of leather. In principle, the leather can derive from any source, including bovine hide, horse hide, goat skin, sheep skin, camel skin, kangaroo hide or the like.

“Bovine” as used herein means, with referral to the traditional taxonomic grouping, a group of animals including e.g. cattle, ox, yak etc.

The term “staple fiber” refers to fibers of discrete length and may be of any composition. Staple fiber may e.g. be provided by division of a keratin-based filament into discrete staple fibers of a certain length. The length may vary dependent on the application.

The term “reconstructed” fiber refers to staple fibers produced on the basis of a number of mechanically sub-divided protein fibrils. The reconstructed fiber may be formed from a protein suspension directed through a nozzle onto a surface for drying. The suspension is dried to remove water and solvent from the suspension and thereby the reconstrued fiber is formed e.g. on a belt or a cylinder surface. Such a manufacturing method of reconstructing fibers on the basis of protein fibrils is e.g. illustrated in WO 2018/149950 or WO 2018/149949 for the use in relation to collagen.

“Nonwoven” as used herein and as defined generally by European Disposables and Nonwovens Association (EDANA) is an engineered fibrous assembly, primarily planar, which has been given a designed level of structural integrity by physical and/or chemical means, excluding weaving, knitting or paper making. Nonwovens can be manufactured in two main ways; felted or bonded. The fabrics use fibers rather than yarns; these are laid randomly or in a uniform way to make web-like layers. They are held together by either the felting or bonding process.

“Woven” as used herein is generally a woven fabric made by an interlacing of two or more threads.

“Reinforcing” as used herein should be understood as a reinforcing fabric comprising high strength fiber that can be woven or nonwoven. To benefit from the strength properties of the fibers, typically at least one layer will contain the high strength fibers in an oriented fashion, such as woven (including uniweave), monodirectional or multidirectional fabrics.

Tanning is used as the conventional ways of treating leather and may be applied to the invention. The technical definition of tanning is well known in the art, but briefly, according to Anthony D. Covington “Tanning Chemistry” chapter 10, the only strict definition of tanning is the conversion of a putrescible organic material into a stable material capable of resisting biochemical attack. Tanning involves a number of steps and reactions depending on the initial material and the final product.

Direct injection process should be understood as the process of introducing a molten material into a cavity of a mold to achieve a desired shape. The process can be used for the production of outsole or decorative details. During the process, a molten material, normally a polymer, is forced into the cavity of a mold.

The process may be known as DIP or direct injection process and they may be used interchangeably.

The sole can be manufactured from any materiel such as e.g. thermoplastic Rubber Injection Molding Resin (TPR), Polyvinyl chloride (PVC), polyurethane (PU), Ethylene Vinyl Acetate (EVA) and/or the like suitable for a direct injection process. The sole can also comprise several parts possibly manufactured from different materials. Such parts may be molded into the sole or may be attached to the sole by e.g. an adhesive or the like.

Unless otherwise noted in the present application, the meaning of DIP is to be understood as the process of integrating a sole with an upper or at least a part of an upper by and during a DIP process.

Thus, single elements, e.g. pressure absorbers or sole parts may be DIP'ed in separate processes (without being attached to the sole) and then subsequently be inserted into the mold by means of which the sole or a part of the sole is to be molded and integrated with the upper or at least a part of the upper.

The manufacturing process according to embodiments of the invention may be a manual process or may be an at least partly automatic process.

Various exemplary embodiments and details are described hereinafter with reference to the figures when relevant. It should be noted that the figures may or may not be drawn to scale and the figures are only intended to facilitate the description of the embodiments.

### THE FIGURES

The invention will be explained in further details below with reference to the FIGS. of which

FIG. 1 illustrates a footwear,

FIG. 2a-2c illustrate further examples of footwear,

FIG. 3 illustrates a mould for direct injection process,

FIG. 4 illustrates a mould for direct injection process including a sock,

FIG. 5a-5c illustrate a mould for direct injection process including a mould closing member, a sock and examples of footbeds.

FIG. 6 illustrates a mould for direct injection process including vacuum conducting member members in the side moulds,

FIG. 7a-7d illustrate the positions of the medial and lateral and further the side surface attachment length and total circumference attachment length,

FIG. 8a-8l illustrate positions of upper and upper layers,

FIG. 9a-9c illustrate examples of form and parts of the footwear upper,

FIGS. 10a-f illustrate further examples of forms and parts of the footwear upper,

FIGS. 11a-i illustrate a further example of a mould for a direct injection process for manufacturing a footwear according to embodiments of the invention and examples of manufacturing steps involved,

FIG. 12 shows a further example of an embodiment of a mould for a direct injection process for manufacturing a footwear according to the invention, seen in an open position from one end,

FIG. 13 shows the embodiment of a mould for a direct injection process as shown in FIG. 12, but in FIG. 13 seen in a perspective view from above and from a position near one end and side of the mould, and

FIG. 14 corresponds to FIG. 13, but wherein for illustrative purposes a footwear upper has been fixated to the second fixating wall of the second side mould.

### DETAILED DESCRIPTION

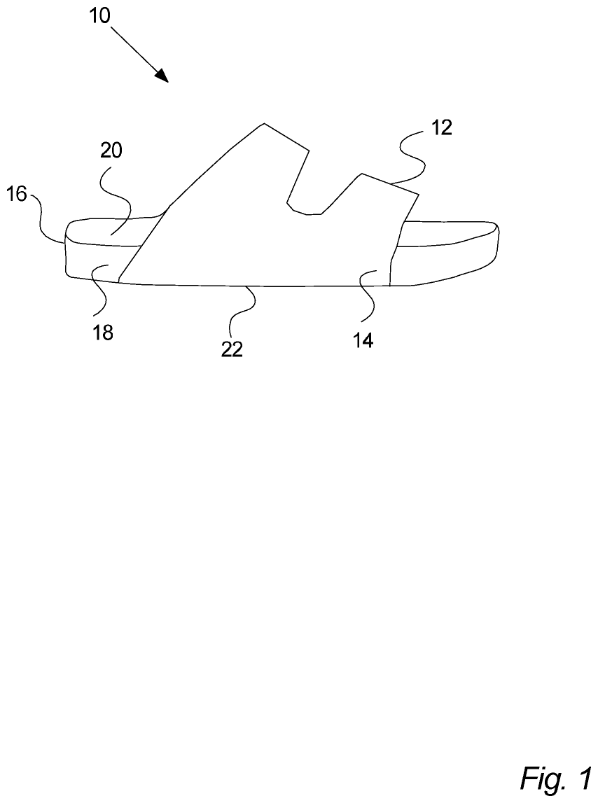

FIG. 1 illustrates a footwear 10.

The exemplified footwear disclosed in FIG. 1 is a sandal according to embodiments of the invention. The footwear 10 is assembled as a footwear upper 12 attached to a sole 16, with the footwear upper lower end 14 attached to the sole side surface 18. As indicated, the sole further comprises an upper facing surface 20 and a ground facing surface 22.

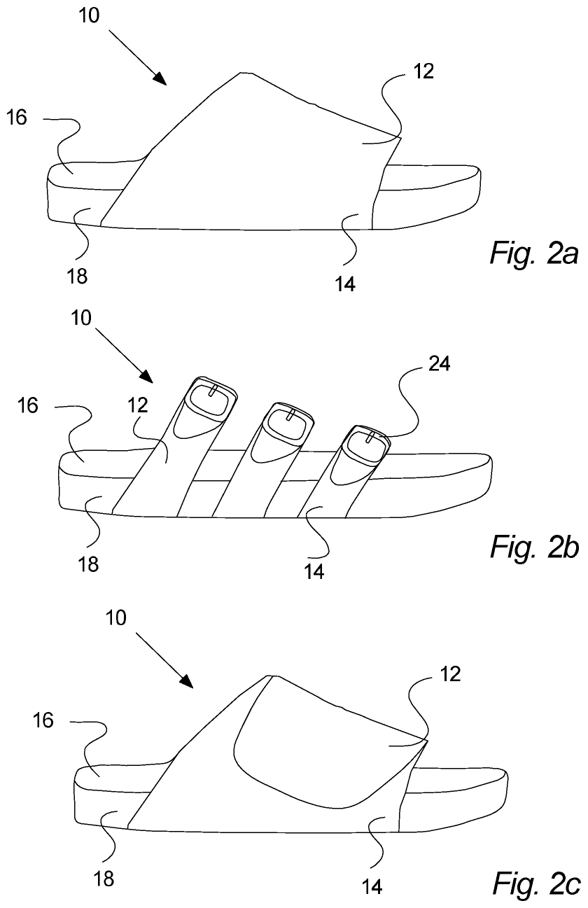

FIG. 2a-2c further illustrate examples of a footwear 10.

The exemplified footwear disclosed in FIG. 2a-2c are variants of the footwear disclosed in FIG. 1 and illustrates that the footwear upper 12 may have many variants such as e.g. one strap, two straps or several straps as illustrated in the sandal in FIG. 2b with three straps. The straps may also comprise a buckle or several buckles 24 to mediate an adjustable closure system to help anchor the foot and provide greater stability and support. The adjustable closure system can also comprise other closure systems such as e.g. Velcro.

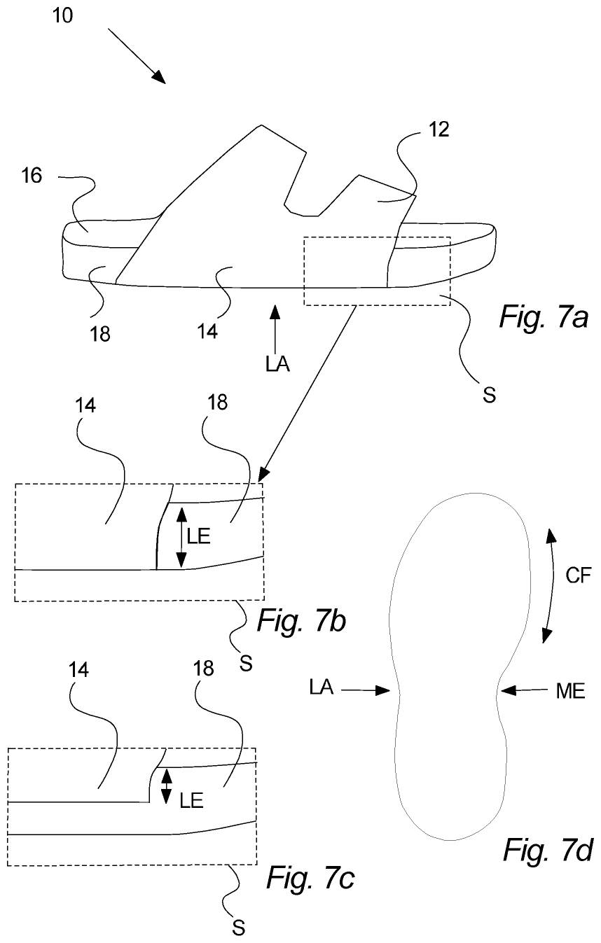

The upper 12 may be manufactured as one part and anchored by a DIP (Direct Injection Process) to the sole side surfaces 18 at the medial ME and lateral LA positions as illustrated in FIG. 2a or may be manufactured as at least two parts as illustrated in FIG. 2b and FIG. 2c and then DIP'ed to the side surfaces 18 of the medial ME and lateral LA side. The medial ME and lateral LA positions are illustrated in FIG. 7d.

The examples of FIGS. 1 and 2a-2c illustrate the sandal as a slip-on sandal, but in other examples the sandal could also be flip flops, sports sandals, everyday flats, dressy flats, slides, wedge sandals, gladiator sandals, thong sandals or any other type of sandal.

The sole may comprise several parts and layers (not shown) and the footwear upper may comprise other not-shown features and parts.

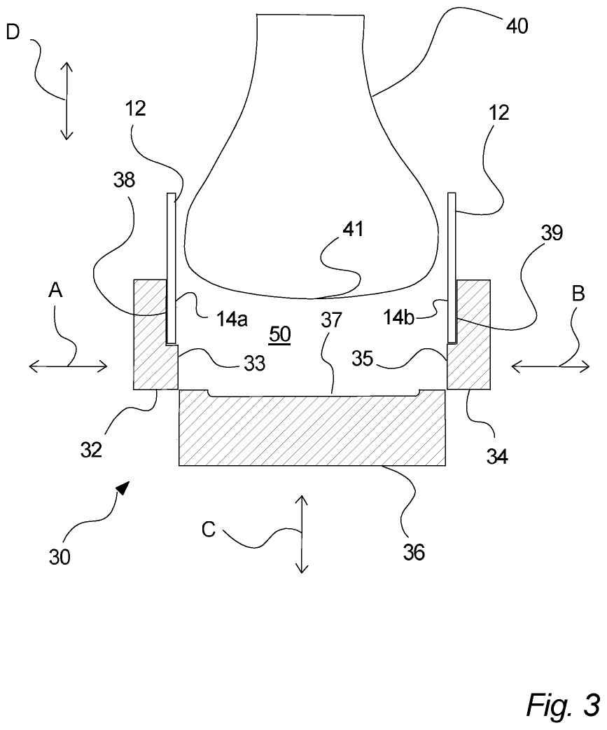

FIG. 3 illustrates a mould for direct injection process according to embodiments of the invention.

This figure shows schematically a mould 30 and a last 40, both seen in a cross-sectional view, which mould 30 and last 40 may be utilized for direct injection moulding of footwear.

The mould may have been manufactured out of metal, for example aluminum by e.g. CNC machinery and may as shown in FIG. 3 comprise a first side mould 32, a second side mould 34 and a bottom mould 36, which are arranged in such a manner that the mould may be opened and closed e.g. by the first side mould 32 and the second side mould 34 being able to be moved in horizontal directions as indicated with the arrows A, B and by the bottom mould 36 being arranged to be moved in the vertical direction as indicated with the arrow C.

The first side mould 32 and the second side mould 34 may be provided with a first side surface 33 and a second side surface 35, respectively, that have been made during e.g. CNC milling, and which generally define a desired form of a side part of a shoe sole to be moulded. Further the bottom mould 36 may correspondingly be provided with a bottom inner surface 37, which have been made during the e.g. CNC milling and which generally has a form corresponding to a desired form of the underside of the shoe sole to be moulded.

Further, as shown in FIG. 3, the first side mould 32 and the second side mould 34 may be provided with a first fixating side wall 38 and a second fixating side wall 39, respectively, and which generally position and fixate the footwear upper lower end. The footwear upper lower end comprises a footwear lower end 14a fixated to the first fixating side wall 38 and a footwear lower end 14b fixated to the second fixating wall 39.

The mould may also include a mould closing member, here exemplified as a last 40, which can be moved in various directions including downwards in relation to the mould 30 as indicated with the arrow D. It will be understood that when performing such a step, it is required that the mould 30 is in an open state in order to allow the last 40 to move into the mould 30. Hereafter the mould may be closed, thus forming a mould cavity 50 between the last 40 (e.g. a member positioned at the last bottom part 41), the first side mould 32, the second side mould 34 and the bottom mould 36.

The fixation of the footwear uppers lower ends 14a and 14b to the first fixating side wall 38 and a second fixating side wall 39, respectively, remains active during the closure of the mould 30 securing the position of the footwear upper and especially the footwear upper lower ends 14a and 14b during the direct injection process of the sole.

The fixation of the footwear uppers lower ends 14a and 14b to the first fixating side wall 38 and a second fixating side wall 39, respectively, can be facilitated in various ways, such as by e.g. adhesive and/or vacuum and will be further elucidated in the following examples.

The mould 30 is attached to injection moulding equipment (not shown in the figures), by means of which injection material is injected into the mould cavity 50, where it comes into contact with the first side surface 33, the fixated footwear upper lower end 14a, the second side surface 34, the fixated footwear upper lower end 14b and the bottom inner surface 37 and the bottom parts of the last 41 (e.g. in practice a shoe part positioned at the last bottom part 41).

When the injected material has taken the shape of the mould cavity it is cured and the injection material has mediated the attachment of the footwear upper 12 to the sole that has been manufactured.

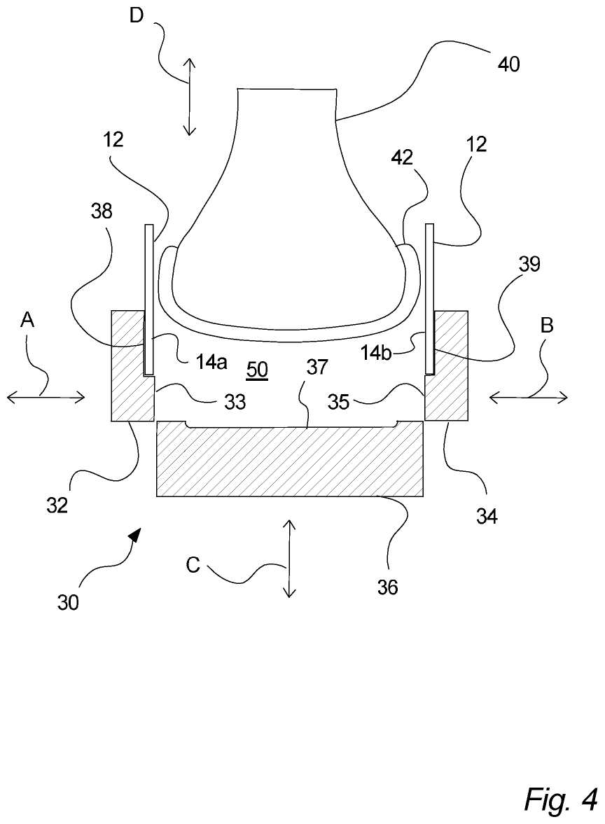

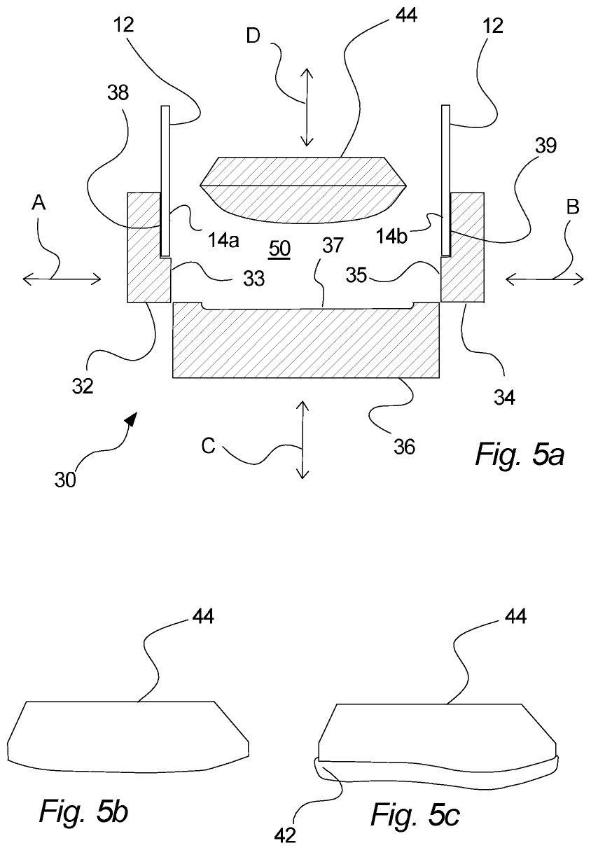

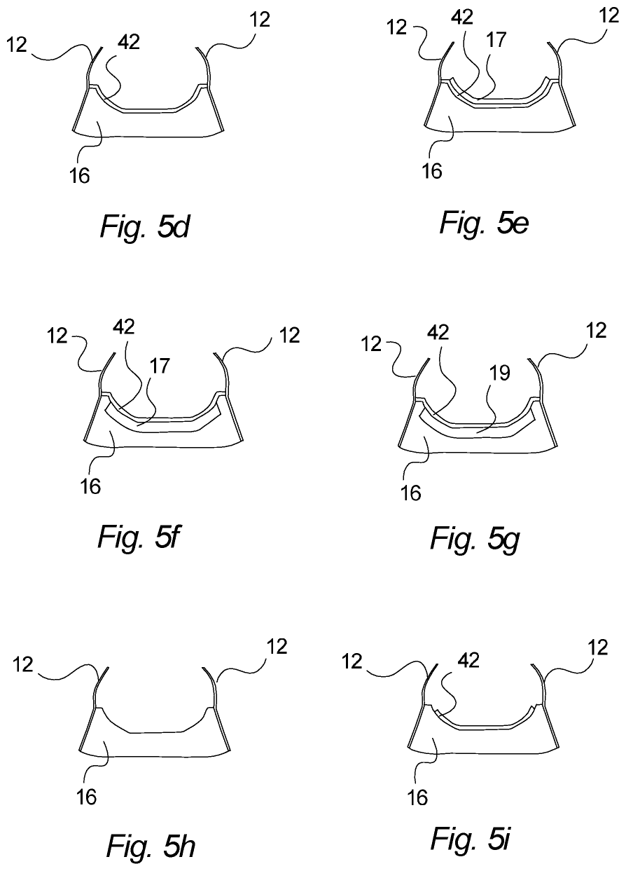

The last exemplified in FIG. 3 should generally be understood as a mould closing member and will be further elucidated in connection with FIGS. 4-5.

FIG. 4 illustrates a mould for direct injection process including a so-called sock according to embodiments of the invention.

The figure is a variant of FIG. 3, wherein the closing member e.g. a last 40 is covered at least partly by a sock 42. The sock 42 and the bottom part 41 of the last 40 mediates the closure of the mould during the direct injection process.

The sock may be manufactured in any material but preferably in a soft material that can tolerate the temperatures during a direct injection process. The material of the sock may e.g. be leather, textile or similar material and should be easy to remove after the direct injection process by itself or with the application of a second material. The sock may further be provided with strings or similar to fix the sock to the closing member e.g. a last 40. The closing member may also be provided with e.g. vacuum to fix the sock to the closing member.

Sock and cover may be used interchangeably.

An advantage of providing the closing member, e.g. a last 40, with a sock 42 is to mediate a closure of the mould. Further and highly advantageously the sock may also be a part of the sole during a direct injection process.

FIG. 5a illustrates a mould for direct injection process including a mould closing member according to embodiments of the invention.

The figure is a variant of FIGS. 3 and 4, wherein the difference lies is the closure of the mould. FIG. 5a-5c illustrates a mould closing member exemplified as a so-called dummy last 44 for closing of the mould during direct injection process to keep the direct injection material e.g. PU in the form during the process. The mould closing member, e.g. a dummy-last 44, may be a loose, e.g. separate part that can be applied to the mould prior to the direct injection process or the mould closing member may also be a part of the mould.

By using a dummy last 44 as a mould closing member, the montage process differs from the conventional process by an absent lasting process of the upper on the machine last. Instead the sock is attached to the dummy last.

FIG. 5b-5c illustrate a side view of the mould closing member, e.g. dummy last 44, where 5b shows an example of a dummy last 44 and 5c shows an example of a dummy last 44 including a sock 42.

The sock may further be provided with padding, other layers and/or additional materials such as e.g. EVA, PU, cork or the like making up a footbed. However, a footbed may also be without the sock and attached directly to the dummy last 44 or at least touching the dummy last during manufacture.

A footbed in the present context, unless otherwise noted, may thus e.g. include both insole (if present), different sole members and/or layers. In particular embodiments of the invention further layers or members may be attached to the footbed or the layers may be included within the footbed.

Hereby, several variations of the order of the materials of the footbed are possible either as a single material or as sandwich constructions of materials.

An example could be a sock placed on a dummy last and during a direct injection process, the sock would then come into contact with the sole material e.g. PU. The sock could further be provided with patterns to provide the sole with e.g. text or different aesthetic appearances on the upper facing surface of the sole. In such case, the sock is not a part of the sole and removed from the sole after the direct injection process and an example hereof is shown in FIG. 5h. Slip-agent may be added to this process to provide the intended removal of the sock from the footbed.

The sock may also become a part of the sole as a footbed during the direct injection process and thereby provide the upper facing surface with a comfortable surface for the user of the footwear and e.g. more wear-resistant soles. In such case, the sock is not removed from the sole and a trimming process may also be needed.

FIG. 5d-5i illustrate a cross sectioned sole 16 and different examples of the order of the materials of the footbed. These should only be understood as examples and the order may be different from the shown examples and the footbed may also contain other materials than in the shown examples.

FIG. 5d shows an example of the sole 16 provided with a sock 42.

FIG. 5e and FIG. 5g show examples of sandwich constructions of the footbed where an additional layer 17 and/or additional members 17 can be positioned on the sock 42 either in contact with the sole upper surface as shown in FIG. 5e, and/or as shown in FIG. 5f in contact with the sock 42 and sole 16. The additional layer 17 can be any material, such as e.g. EVA, PU, cork or the like, have various thickness and there may be several additional layers. An additional layer may also be a gasket or similar (not shown) with the advantage of making a separation of the different layers or keeping a shape of a layer e.g. foam.

As shown in FIG. 5e and FIG. 5f, the additional layer 17 and/or additional member may both be regarded as a part of the footbed either by being included within the footbed as in FIG. 5f or attached onto the footbed as disclosed in FIG. 5e.

The constructions may also include foam 19 that e.g. can be positioned between the sole 16 and the sock 42 as shown in FIG. 5g and hereby provide a softer and more comfortable sole. The foam can be positioned on the sock 42 either in contact with the sole upper surface and may vary in thickness and also have several layers. This layer 19 may also be regarded as an additional layer, but in the present context this layer is regarded as part of the footbed.

The sock 42 may only extend partially the length of the sole 16 as shown in FIG. 5i.

A footbed should be understood as the part of the shoe that runs under the bottom of the foot to the sole material. It may have layers of construction and structural elements added for e.g. better fit and comfort.

Foam should be understood as any types of foam suitable for footwear and may be a soft plastic that is filled with air bubbles. The properties of different foams are created using different types of plastic, controlling the size and controlling the character of the air bubbles.

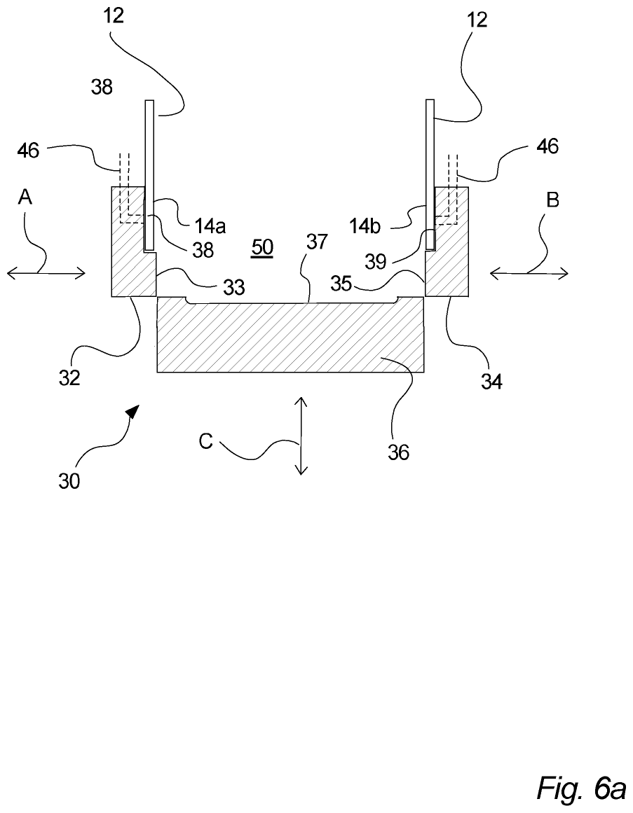

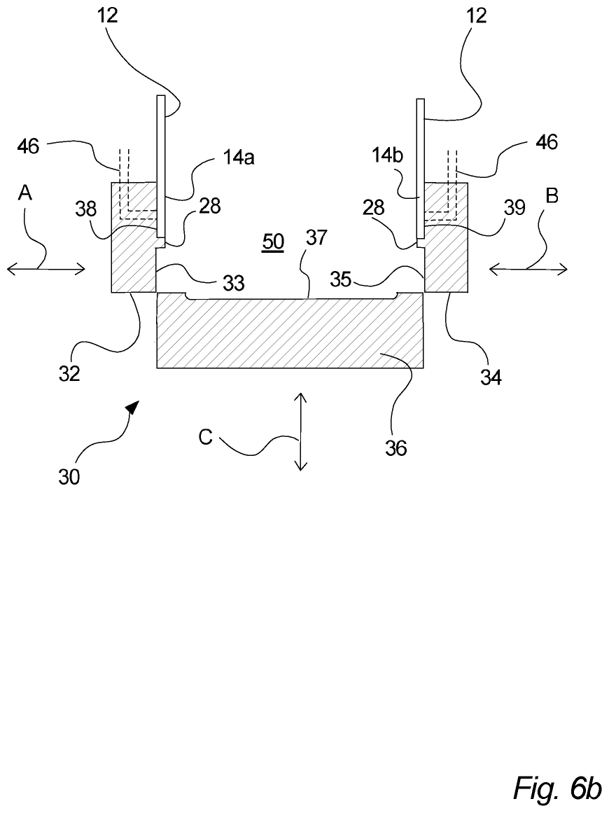

FIG. 6a illustrates a mould for direct injection process including a vacuum conducting member according to embodiments of the invention.

The figure is a variant of FIGS. 3-5, wherein the difference is vacuum conducting members 46 used for fixation of the footwear upper 14a, 14b to the first fixation wall 38 and the second fixation wall 39, respectively. The vacuum conducting members 46 can enter the mould from the top of the mould as illustrated in FIG. 6, however, the vacuum conducting members 46 may also enter from the sides or bottom of the mould. There may also be more than one vacuum conducting members in connection with the first fixation wall 38 and the second fixation wall 39, and the vacuum conducting members may have various forms of the holes and may include vacuum channels.

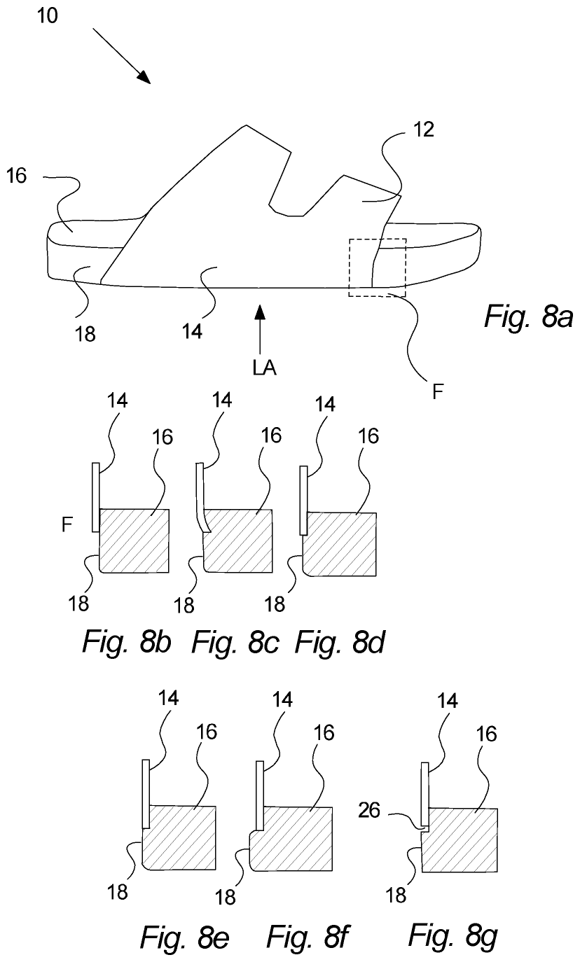

FIG. 6b is a variant of FIG. 6a and illustrate an example of modified side moulds 32,34 both having a protrusion 28 as a part of the side moulds. The protrusions result in a groove as illustrated in FIG. 8g and advantages of such protrusion and the resulting groove is to position the upper lower end securely and reliably relative to the side moulds during DIP and further to make space for excess sole material and prevent overflow of sole material.

FIG. 7 illustrates the medial and lateral positions and further illustrates the side surface attachment length and total circumference attachment length of a footwear.

FIG. 7a illustrates a footwear 10 comprising a footwear upper 12, a footwear upper lower end 14, a sole 16 and a sole side surface 18. S represents a selected part the footwear upper lower end 14 and sole side surface 18 for the illustration of the side surface attachment length and is further explained in FIG. 7b.

FIG. 7b illustrates the side surface attachment length LE and should be understood as the length where the footwear upper lower end 14 is attached to the sole side surface 18. The side surface attachment length LE can be an attachment of the footwear upper at the entire sole side surface 18 as illustrated in FIG. 7b, however, the attachment length may vary as illustrated in 7c to be e.g. half of the entire sole side surface according to embodiments of the invention.

FIG. 7d illustrates a footwear or sole from above showing the locations of the medial ME and lateral LA positions on the footwear according to embodiments of the invention. Medial ME and lateral LA should be understood as the anatomical terms of location, wherein medial is the location toward the midline of the body and lateral refers to the side of the body that is away from the midline. The lateral LA location of the footwear 10 has also been indicated in FIG. 7a. The medial ME location is hidden on the opposite side of the shoe and is not shown in FIG. 7a.

Further, the footwear in FIG. 7d illustrates the total circumference attachment length CF and should be understood as the total circumference attachment of the footwear upper to the sole. Examples hereof could be a footwear having a thin strap with the result that the total length circumference attachment length would be smaller than a footwear having a wide strap.

The circumference length CF may be small with thin straps such as e.g. 1 cm or the total circumference CF may be higher with wide straps such as e.g. a total CF of 5 cm, meaning two straps of each 2.5 cm. The straps may of course be wider such as e.g. 5 cm each with the total CF of 10 cm. The footwear upper may also be attached to the total sole side surface without any gaps, meaning that the CF would vary dependent of the size of the footwear but should then be understood as a CF of 100%.

FIG. 8a-8l illustrate examples of placement of the upper on the sole side surface and layers of the upper.

FIG. 8a illustrates a footwear 10 comprising a footwear upper 12, a footwear upper lower end 14, a sole 16 and a sole side surface 18. F represents a selected part the footwear upper lower end 14 and sole side surface 18 for the illustration of the placement of the upper lower end 14 on the sole side surface 18.

FIG. 8b-8f illustrate examples of different placements of the upper lower end 14 on or in the sole side surface 18 from a front or back view of a part of a sole 16 seen in a sectional view. In more details, FIG. 8b shows an example of an upper lower end 14 attached to the outside of sole side surface 18; FIG. 8c shows an example of an upper lower end 14 attached partly to the outside of sole side surface 18 and partly moulded into the sole 16; FIG. 8d shows an example of an upper lower end 14 partly moulded into the sole 16 on the sole side surface 18, where e.g. half of the upper 14 is the in the sole 16 and half of the upper is outside of the sole 16 on the sole side surface 18; FIG. 8e shows an example of an upper lower end 14 moulded into the sole 16; FIG. 8f shows an example of an upper lower end 14 moulded into the sole side surface 18 is extending the upper lower end 14. FIG. 8g illustrates an example of a placement of the upper having a distance from the sole material and wherein the distance makes a groove 26 to make space for excess of sole material if relevant. The groove can have the same thickness as the upper material or less or more. The grove may also be understood as a colour dam.

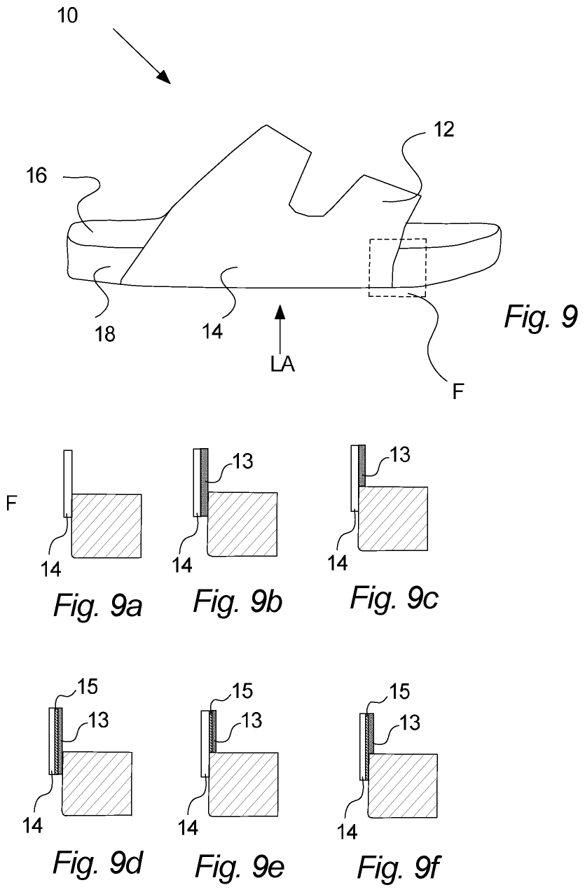

FIG. 9 illustrates a footwear 10 comprising a footwear upper 12, a footwear upper lower end 14, a sole 16 and a sole side surface 18. F represents a selected part of the footwear upper lower end 14 and sole side surface 18 for the illustration of the placement of the upper lower side 14 on the sole side surface 18.

FIG. 9a-9f show examples of a footwear upper including various layers. In more details, FIG. 9a shows an example of a single layer upper 14; FIG. 9b shows an example of an upper 14 and a lining 13, where the lining 13 and the upper 14 have the same length; FIG. 9c also shows an example with an upper 14 and a lining 13 that is shorter than the upper; FIG. 9d shows an example of an upper 14, a reinforcing layer 15 and a lining 13 where the layers have the same length; FIG. 9e shows an example of an upper 14, reinforcing layer 15 and a lining 13, where both the reinforcing layer 15 and the lining 13 are shorter than the upper 14; and FIG. 9f shows an example where only the lining 13 is shorter than the upper 14 and the reinforcing layer 15.

The various layers may vary according to material, their position and length of the different layers and the layers can also be other material than shown in the examples. The construction of a footwear having an upper comprising several layers, may also include a groove 26 (not shown) as illustrated in FIG. 8g.

A reinforcing layer should be understood as a layer of e.g. fabric to strengthen the upper material making it possible to use thinner upper materials. Examples of such reinforcing fabric could be the commercially available reinforcing fabrics from e.g. Dyneema.

Lining is defined as the material inside of the shoe that may come into contact with the entire foot; sides, top and heels. The lining may be any suitable material such as e.g. leather or fabric such as cotton and viscose and/or synthetic material like e.g. polyester, acrylic and elastane.

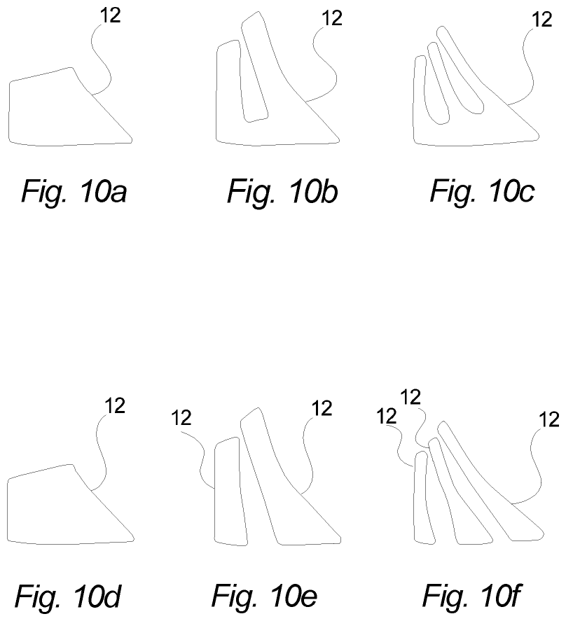

As already discussed in FIG. 2a-2c, the footwear upper part or parts 12 can have many forms and patterns and FIG. 10a-10f further illustrate examples hereof. FIG. 10a-10d illustrate examples of uppers as one piece, where FIGS. 10e and 10f show examples of uppers consisting of two or more pieces of upper. These examples are not limited to the shown examples and the upper may also contain more than three pieces, such as 4, 5 or even more and have other forms and appearances. In these examples, the attachment length may vary.

In general, the footbed can be fixed in relation to the mould closing member or engaging the mould closing member e.g. a dummy last by any possible methods. An example could be that the sock is fixed to the dummy last by strings and the dummy last may also be provided with vacuum conducting members where vacuum is used to fix the sock to the dummy last. It may also be a footbed that is fixed to the dummy last or it can be several layers of materials e.g. a sock and additional layers fixed to the dummy last. Here the different layers may also be fixed together by e.g. adhesives. The footbed may be constructed as a part of the direct injection process but can also be a pre-made footbed.

The vacuum holes and channels can be positioned any place on the dummy last and the holes may have any form.

The last, mould closing member and dummy last may be used interchangeably in these examples as well as in the following examples and according to embodiments of the invention.

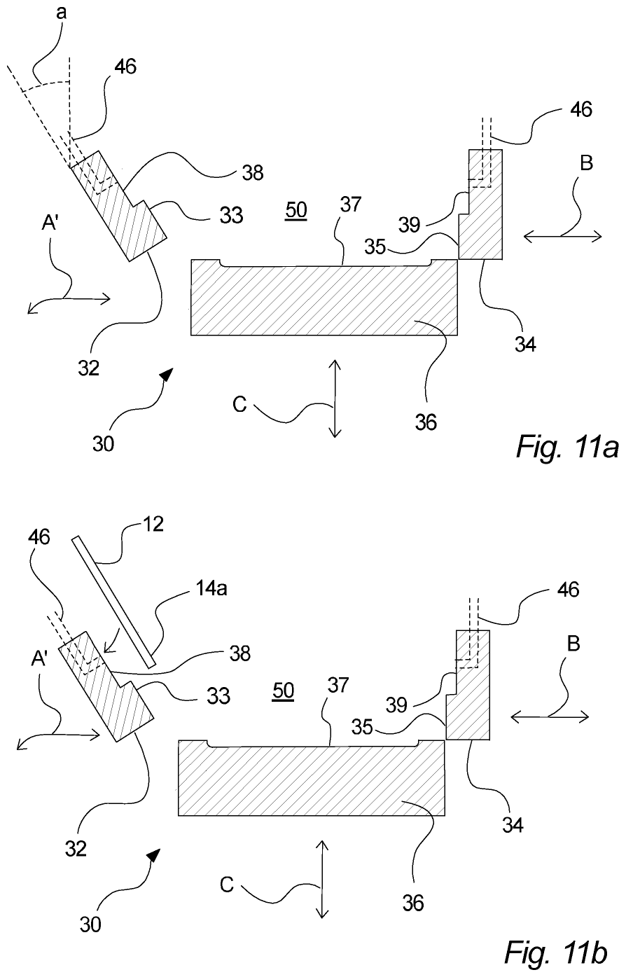

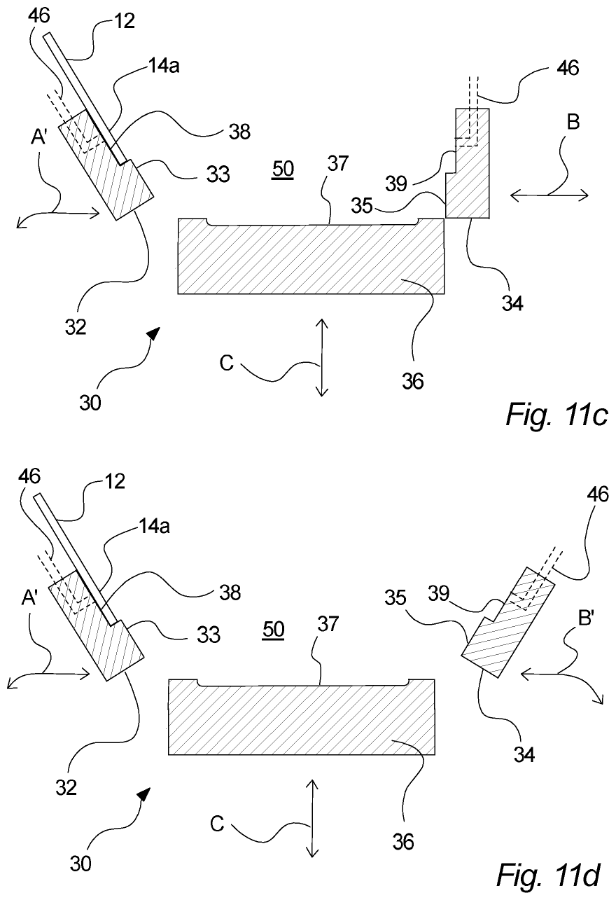

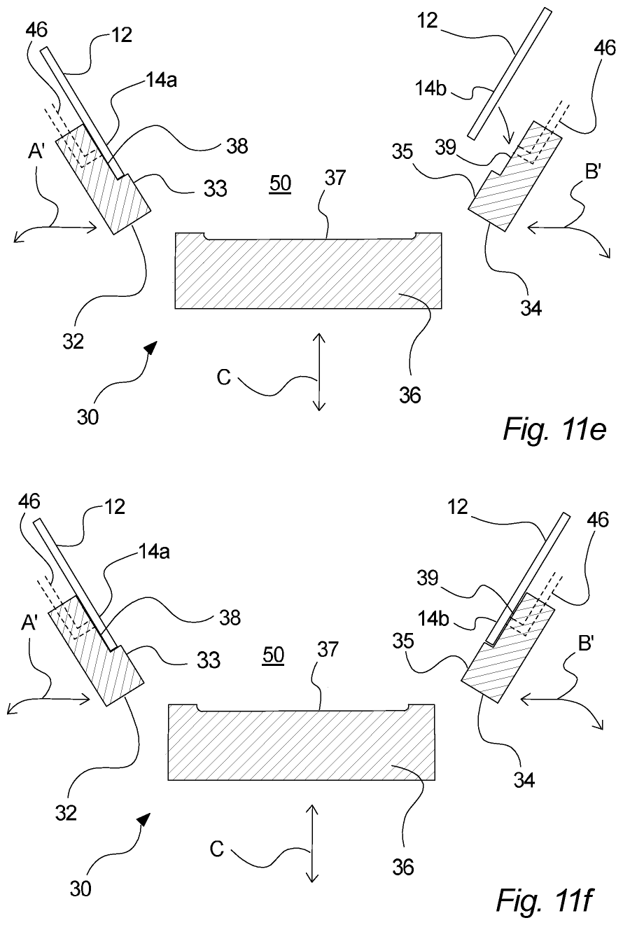

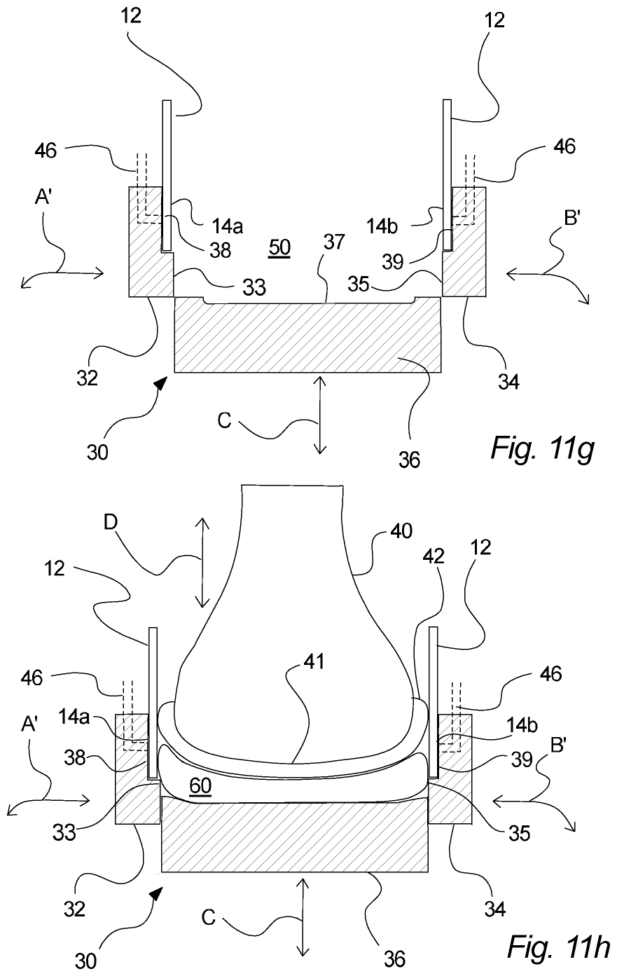

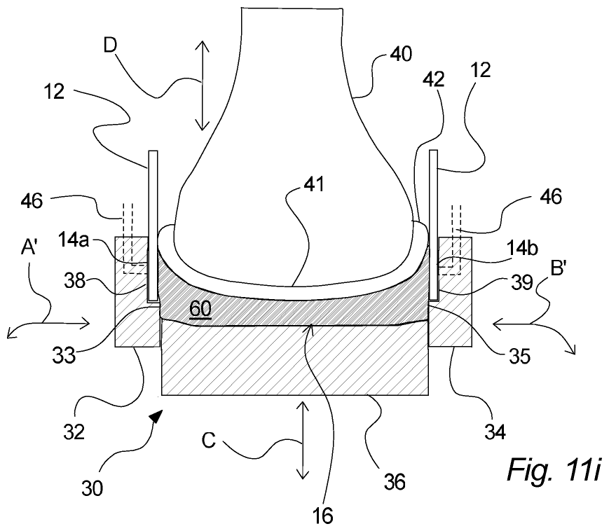

In FIGS. 11a-i a further example of a mould 30 for a direct injection process for manufacturing footwear according to embodiments of the invention is illustrated in a schematic manner and furthermore examples of manufacturing steps involved are illustrated as it will be elucidated in the following.

FIG. 11a shows such a mould 30, e.g. essentially corresponding to the mould that is shown in FIGS. 3, 4 and 5a and more particularly as shown in FIG. 6a as the first side mould 32 and the second side mould 34 are configured for fixating parts of footwear upper 12 by vacuum. Thus, the first side mould 32 and the second side mould 34 are connected to vacuum conducting members 46, which may provide vacuum to openings such as holes, channels, etc in the surface of the first fixating side wall 38 and the second fixating side wall 30, respectively as it has been disclosed previously.

In FIG. 11a only the essential parts have been shown, e.g. the first side mould 32, the second side mould 34 and the bottom mould 38, but it will be understood that e.g. means for moving the respective parts will be necessary. However, for reasons of clarity these have been omitted in FIG. 11a.

As illustrated with the double-arrow A′, the first side mould 32 may be moved not only horizontally but may also be pivoted or tilted as shown in FIG. 11a. Possibly, it may only be necessary to pivot the first side mould 32 to obtain a necessary distance to e.g. the second side mould 34 and/or a last or another type of mould closing member (dummy last). However, as illustrated a combination of a horizontal movement and a pivotal movement may be applied. As further shown in FIG. 11a with dashed lines, the first side mould may be pivoted an angle a in relation to the vertical position, which is the position usually taken by the first side mould, e.g. in case the mould 30 is positioned with the bottom mould positioned horizontally and the side moulds perpendicular to the bottom mould. By the first side mould being pivoted, it will be seen that access to the first fixating side wall 38 is improved considerably. This is illustrated in FIG. 11b, where it is shown that a schematically illustrated footwear upper 12 is being moved (as illustrated with the arrow) to be positioned with its footwear upper lower end 14a at a desired position at the first fixating side wall 38, while vacuum is provided to fixate the footwear upper. It is noted that the positioning may be effected manually by an operator or in a more or less automated manner.

It is noted that the angle a may be within an interval from 0° to 10°, from 0° to 20°, from 0° to 30°, from 0° to 45°, from 0° to 60°, from 0° to 75° or even more in relation to the vertical position. For example, the angle may be around 10°, around 20°, around 30°, around 45°, around 60°, around 75° or even more in relation to the vertical position.

In FIG. 11c it is illustrated that the footwear upper 12 has been positioned on the first fixating side wall 38 and has been fixated by vacuum. It is noted that a footwear upper 12 may be fixated to the second side mould 34 in the scenario shown in FIG. 11c, e.g. with the second side mould 34 being moved only in a horizontal direction prior to positioning of a footwear upper.

However, as shown in FIG. 11d, the second side mould 34 may also be moved not only horizontally but may also be pivoted as indicated with the double-arrow B′. Hence, access to the second side mould 34 and the second fixating side wall 39 has been improved considerably, and subsequently, a footwear upper 12 may be positioned with its lower end 14b on the second fixating side wall 39 as illustrated in FIG. 11e and in FIG. 11f, where in FIG. 11f it is shown that the footwear upper 12 has been positioned on the second fixating side wall 39 and has been fixated by vacuum. As noted above, the positioning of the footwear upper 12 may be effected manually by an operator or in a more or less automated manner.

It is noted that, corresponding to what has been described above concerning the first side mould 32, the second side mould 34 may be pivoted an angle a in relation to the vertical position (not shown in the figures). Also, the angle a for the second side mould 34 may be within or around the same angles as has been stated above for the first side mould 32.

It will be understood that only one or both of the first side mould 32 and the second side mould 34 may be pivoted or tilted, when moved outwards, and that they may be moved at the same time or one after the other, for example one being moved outwards and pivoted, whereafter the other is being moved outwards and pivoted. Other scenarios and combinations are possible, as it will be apparent to a skilled person.

When a footwear upper 12, possibly comprising more than one piece at each side, has been fixated to the first side mould 32 and the second side mould 34, the manufacturing process may proceed, e.g. by the first side mould 32 and the second side mould 34 returning to the upright position and moving towards the mould cavity, e.g. as schematically illustrated in FIG. 11g. However, as it will be understood, the inward movements are not finalized until e.g. a last 40 as shown in FIG. 11h or another type of mould closing member (dummy last) has been positioned in relation to the mould 30. In FIG. 11h this is illustrated with a last 40, on the bottom part 41 of which a sock 42 has been positioned. The first side mould 32 and the second side mould 34 has been moved inwards toward the last 40 until the mould 30 has been closed, e.g. with the footwear upper lower ends 14a and 14b abutting the sock 42 and with the sock 42 closing off to the first side surface 33 and the second side surface 35 of the first side mould 32 and the second side mould 34, respectively. Furthermore, the bottom mould 36 is being moved upwards to a position defining the height, e.g. thickness of the sole 16 that is being moulded.

In FIG. 11h, it is shown that a required amount of direct injection process material 60 has been injected into the mould cavity 50, where it will expand to fill the mould cavity and take the shape of the mould cavity. In FIG. 11h it is shown that the direct injection process material 60 has only partly expanded, but it will expand to fill the voids within the mould cavity 50 and will thus bond to the footwear upper lower ends 14a and 14b, thereby attaching the footwear upper lower ends to the side surfaces of the sole that is being manufactured.

In FIG. 11i, it is shown that the direct injection process material 60 (as indicated with the hatching) has expanded fully to fill the mould cavity 50 and form a sole 16, e.g. as elucidated above, and bonded the direct injection process material 60 to e.g. the footwear upper lower ends 14a and 14b, thereby attaching the footwear upper lower ends to the side surfaces of the sole 16 that is being manufactured. Upon curing, the mould may be opened and the footwear may be removed and may possibly be subjected to after-treatment.

It is noted that e.g. an outsole (not shown in FIGS. 11h and 11i) may be placed at the bottom mould 36 prior to injection of the direct injection process material 60.

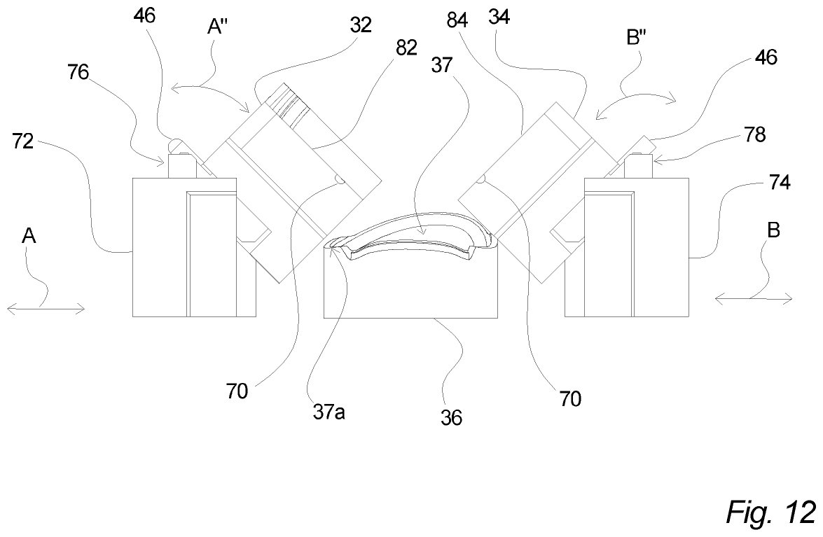

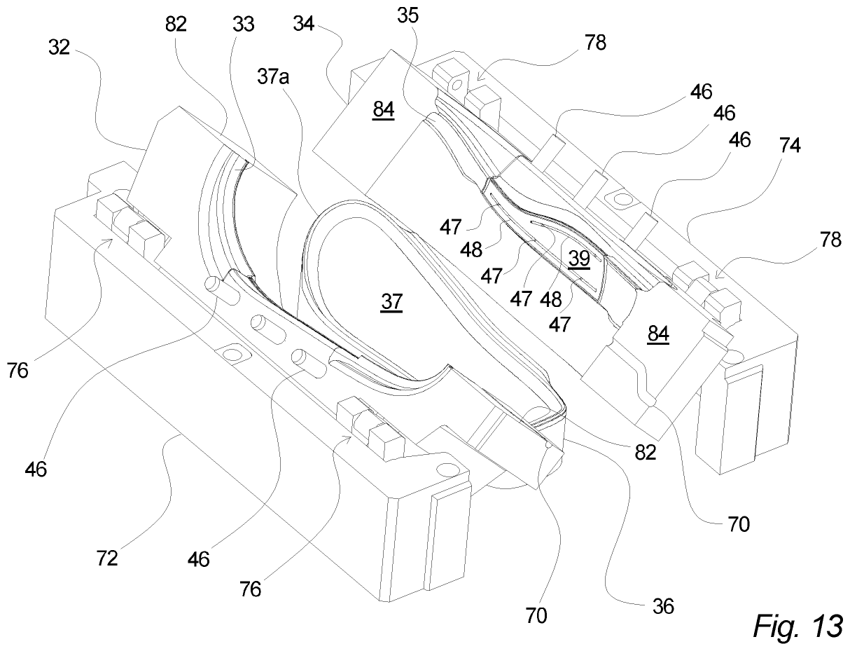

A further example of an embodiment of a mould 30 for a direct injection process for manufacturing a footwear according to the invention will be elucidated with reference to FIGS. 12 and 13, where the mould 30 in FIG. 12 is seen in an open position from one end, e.g. the heel end of the mould. The mould 30 comprises here a pair of side frames, e.g. a first side frame 72 and a second side frame 74, which as indicated by the arrows A and B may be horizontally movable when the mould 30 is being opened and/or closed again. Furthermore, a pair of side moulds, e.g a first side mould 32 and a second side mould 34 are connected to the first side frame 72 and the second side frame 74, respectively, by a first side hinge 76 and a second side hinge 78, which each may comprise one, two or more individual hinges as it has been illustrated in FIG. 13. Thus, as shown in FIG. 12 by the double-arrows A″ and B″, the first side mould 32 and the second side mould 34 may be tilted or pivoted in relation to the side frames. It will thus be apparent that a multitude of movements are possible, when opening the mould, e.g. any combinations of a horizontal movement of a side frame and a pivotal movement of the corresponding side mould, whereby the advantages as mentioned above may be achieved, e.g. improved access when positioning a footwear upper.

It is noted that the angle parameters and/or intervals of the pivotal angles in relation to the vertical direction as mentioned above also apply in connection with the embodiment as shown in FIGS. 12 and 13.

As further illustrated in FIG. 12, the first side mould 32 and the second side mould 34 are each equipped with vacuum conducting members 46 for providing vacuum to the respective fixating side walls (not shown in FIG. 12). It is noted, though, that other means than vacuum may be utilized as has been mentioned above, e.g. adhesive, glue, etc.

Further, it is shown that the first side mould 32 has a first side mould end interface 82 and that the second side mould 34 has a second side mould end interface 84, which are designed to meet and close the mould cavity at the end, when the mould 30 is being closed. It is indicated that these interfaces 82 and 84 may be configured to form an injection channel 70, when the mould is closed.

FIG. 12 furthermore shows a bottom mould 36, around which the first side mould 32 and the second side mould 34 close together to close up the mould cavity downwards. It is indicated here that the bottom mould on its upper side is designed with a bottom inner surface 37, which forms the ground facing part of the sole that is being moulded. As indicated, the bottom inner surface 37 comprises at its outer perimeter a brim 37a of the bottom inner surface, which cooperates with the inner surfaces of the first side mould 32 and the second side mould 34 to close the mould in e.g. transverse directions.

FIG. 13 shows correspondingly the embodiment of a mould for a direct injection process as shown in FIG. 12, but where in FIG. 13 it is seen in a perspective view from above and from a position near a corner, e.g. near the end and the side of the mould 30. The mould 30 is shown in FIG. 13 in essentially the same position as in FIG. 12, e.g. in an open position where the first side frame 72 and the second side frame 74 have been moved away from each other and where the first side mould 32 as well as the second side mould 34 have been tilted or pivoted a certain angle via the first side hinge 76 and the second side hinge 78, which as indicated comprises two individual hinges each.

Further, it is shown that each of the side moulds 32, 34 has a plurality of vacuum conducting members 46, e.g. three each, for conducting vacuum via internal channels to the fixating side walls, e.g. the second fixating side wall 39, which is visible in FIG. 13. Here, it is shown that the vacuum is led to a number of vacuum holes 47, which may be arranged to connect with a number of vacuum channels 48, e.g. two vacuum channels 48 as shown in FIG. 13, whereby the vacuum may be transferred to have effect over a certain area as indicated in FIG. 13. It will be apparent that various combinations may be utilized, e.g. including vacuum holes emerging on a surface, some vacuum holes emerging in one or more shared vacuum channels and any possible combinations that may fulfil a specific purpose or intent.

It is noted that e.g. the first fixating side wall 38 (not shown in FIG. 13) and the second fixating side wall 39 may be configured to facilitate positioning the footwear upper lower end 14, e.g. by being at least partly recessed as indicated in FIG. 13, e.g. by milling or the like, or by providing at least a lower supporting protrusion or in any other manner.

As mentioned in connection with FIG. 12, the first side mould 32 has a first side mould interface 82 at the heel end (to the right in FIG. 13) and a corresponding first side mould interface 82 at the toe end (to the left in FIG. 13), which are designed to close the mould cavity 50 in cooperation with corresponding second side mould interfaces 84, when the mould 30 is closed. As mentioned above, at one end (here at the heel end) the interfaces are configured to provide an injection channel 70.

The bottom mould 36 is a described above configured with a bottom inner surface having a brim 37a, e.g. a region at the outer perimeter, which, when the mould 30 is closed, may be moved upwards towards the first side surface 33 and the second side surface 35 to cooperate to define the side and the bottom form of the sole.

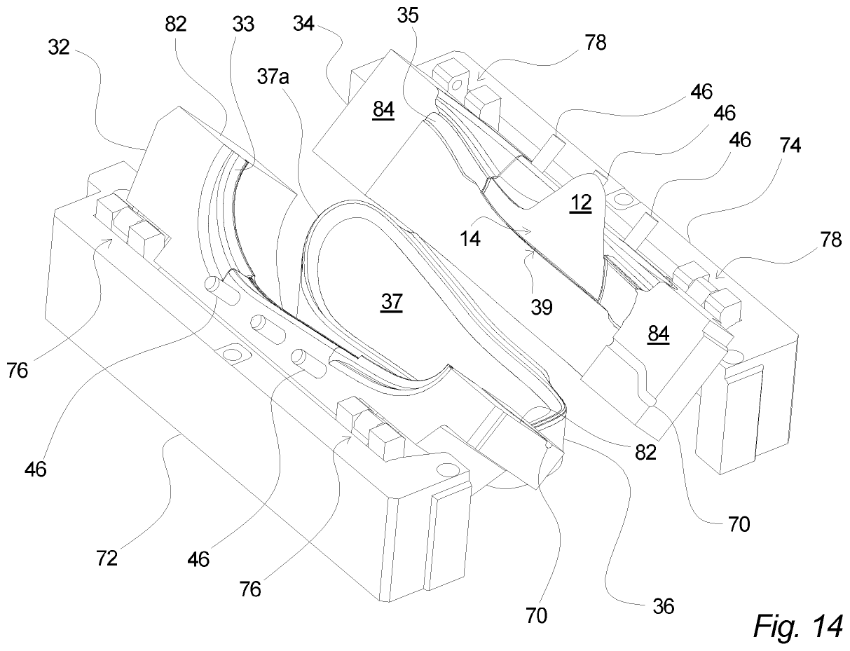

FIG. 14 corresponds to FIG. 13, but in the scenario shown in FIG. 14 an example of a footwear upper 12 has for illustrative purposes been fixated by means of the vacuum provided by the vacuum channels and vacuum holes to the second fixating wall 39, i.e. with the footwear upper lower end 14 being fixated and ready to be bonded to the sole, when the mould 30 is closed (together with a mould closing member, e.g. last, dummy last or the like). As it will be understood this requires that the first side mould 32 as well as the second side mould 34 are being tilted to their upright/vertical positions, the mould is being closed by moving the first side frame 72 and the second side frame 74 together and towards the bottom mould 36 (and a mould closing member, e.g. a last, a dummy last or the like), the bottom mould 36 is moved to a suitable position to define the thickness of the sole and injection material is being injected, whereby the sole is moulded and the footwear upper 12 (and a corresponding footwear upper at the first side mould 32) is bonded to the sole.

In the above description, various aspects and embodiments of the invention have been described with reference to the drawings, but it is apparent for a person skilled within the art that the invention can be carried out in an infinite number of ways, using e.g. the examples disclosed in the description in various combinations, and within a wide range of variations within the scope of the appended claims.

### LIST OF REFERENCES

10 Footwear
12 Footwear upper
13 Lining
14, 14a, 14b Footwear upper lower end
15 Reinforcing layer
16 Sole
17 Additional layer
18 Sole side surface
19 Foam
20 Upper facing surface
22 Ground facing surface
24 Buckle
26 Groove
28 Protrusion
30 Mould for direct injection
32 First side mould
33 First side surface
34 Second side mould
35 Second side surface
36 Bottom mould
37 Bottom inner surface
37a Brim of bottom inner surface
38 First fixating side wall
39 Second fixating side wall
40 Last
41 Last bottom part
42 Sock
44 Mould closing member/dummy last
46 Vacuum conducting member
47 Vacuum hole
48 Vacuum channel
50 Mould cavity
60 Direct injection process material
70 Injection channel
72 First side frame
74 Second side frame
76 First side hinge
78 Second side hinge
82 First side mould end interface
84 Second side mould end interface
A, A′, A″ Sideways, e.g. horizontal and/or pivotal movement of first side mould
B, B′, B″ Sideways, e.g. horizontal and/or pivotal movement of second side mould
C Vertical movement of bottom mould
D Vertical movement of last, closing member or dummy last
LE Side surface attachment length
CF Total circumference attachment length
ME Medial
LA Lateral

1. A footwear, comprising:
a footwear upper; and
a sole,
wherein the footwear upper has a lower end,
wherein the sole has an upper facing surface, a ground facing surface, and a side surface,
wherein the sole side surface comprises a lateral side surface and medial side surface,
wherein the footwear upper lower end is attached to the side surface of the sole at least partly by a direct injection process of the sole, said direct injection process of the sole (16) being provided via a mould comprising at least two side mould parts, and
wherein the footwear upper is attached to the lateral side surface and the medial side surface, respectively.

2. (canceled)

3. The footwear according to claim 1, wherein the footwear is a sandal.

4. The footwear according to claim 1, wherein the footwear upper lower end is at least partly fixated to the mould prior to the direct injection process.

5.-10. (canceled)

11. The footwear according to claim 1, wherein the sole comprises TPR, PVC, EVA, TPU, or PU.

12.-14. (canceled)

15. The footwear according to claim 1, wherein the sole is contoured.

16.-29. (canceled)

30. The footwear according to claim 1, wherein the footwear upper comprises at least one strap.

31.-35. (canceled)

36. The footwear according to claim 1, wherein the footwear upper lower end is attached to the side surface of the sole by a side surface attachment length.

37.-42. (canceled)

43. The footwear according claim 1, wherein the footwear comprises a footbed including a sock, cork, leather, foam, gasket, or PU.

44.-45. (canceled)

46. The footwear according to claim 1, wherein attachment forces between the footwear upper lower end and an outer surface of the sole is at least 5 kN/m, when measured according to ISO 3376: 2011.

47. A method for manufacturing a footwear, said method comprising steps of:
providing a footwear upper, wherein the footwear upper comprises a footwear upper lower end;
providing a mould, wherein the mould comprises at least two side mould parts;
fixating the footwear upper lower end at least partly to the at least two side mould parts;
providing a mould closing member;
closing the mould; and
injecting direct injection material into the mould by a direct injection process for manufacturing of a sole, wherein the sole comprises a side surface and thereby attaching the footwear upper lower end to the side surface of the sole at least partly by the direct injection process for manufacturing of the sole.

48. The method according to claim 47, wherein the step of fixating the footwear upper lower end at least partly to the at least two side mould parts is mediated by vacuum.

49. (canceled)

50. The method according to claim 47, wherein the footwear upper lower end is at least partly fixated to the at least two side mould parts prior to the direct injection process.

51.-52. (canceled)

53. The method according to 47, wherein at least one of the at least two side mould parts of the mould is pivotable, and
wherein, prior to the step of fixating the footwear upper lower end at least partly to the at least two side mould parts, said at least one of the at least two side mould parts has been pivoted to facilitate access for positioning the footwear upper lower end.

54. The method according to claim 47, wherein the step of closing the mould comprises moving said at least two side mould parts towards said mould closing member from each side of the mould closing member.

55. The method according to claim 54, wherein the footwear upper lower end that has been fixated at least partly to the at least two side mould parts, is moved in a direction essentially perpendicular to the footwear upper lower end when closing the mould.

56. The method according to claim 47, wherein the mould further comprises a bottom mould, and
wherein the bottom mould is being moved upwards prior to and/or during the step of injecting direct injection material into the mould to position the bottom mould at a position corresponding to a desired thickness of the sole.

57. (canceled)

58. A system for manufacturing footwear by a direct injection process, said system comprising a mould for direct injection, wherein the mould comprises at least two side mould parts, said at least two side mould parts each being configured for at least partly fixating a footwear upper lower end to the mould for direct injection,
wherein said at least two side mould parts comprise a first side mould and a second side mould, each being configured for at least partly fixating a footwear upper lower end to the mould for direct injection, said first side mould and said second side mould comprising a first fixating side wall and a second fixating side wall, respectively.

59. (canceled)

60. The system according to claim 58, wherein one or both of said at least two side mould parts are pivotable.

61. The system according to claim 58, wherein said at least two side mould parts are each being configured for at least partly fixating said footwear upper lower end by vacuum.

62. The system according to claim 58, further comprising a movable bottom mould or a mould closing member.

63.-64. (canceled)
